(19) United States
(12) Patent Application Publication
(10) Pub. No.: US 2025/0172447 A1
(43) Pub. Date: May 29, 2025

(54) PRESSURE SENSORS AND RELATED METHODS

(71) Applicant: Merit Medical Systems, Inc., South Jordan, UT (US)

(72) Inventors: Shiva K. Pallinti, South Jordan, UT (US); Binh N. Tran, Herriman, UT (US); Rickey E. Russell, Cottonwood Heights, UT (US)

(21) Appl. No.: 18/958,926

(22) Filed: Nov. 25, 2024

Related U.S. Application Data
(60) Provisional application No. 63/603,826, filed on Nov. 29, 2023.

(51) Int. Cl. G01L 9/00

(52) U.S. Cl. CPC G01L 9/0052

(57) ABSTRACT

An example pressure sensor comprises a die. The die comprises at least one lateral section and a diaphragm extending between opposing portions of the lateral section. The lateral section and the diaphragm define a top surface and the lateral section define a bottom surface opposite the top surface. The lateral section and the diaphragm partially define a first cavity. The pressure sensor further comprises a top glass layer positioned adjacent to a portion of the top surface. The top glass layer partially defines a second cavity adjacent to the diaphragm. The pressure sensor also comprises a polysilicon layer between the top glass layer and a corresponding portion of the top surface. The polysilicon layer couples the top glass layer to the die.

### TECHNICAL FIELD

This application claims priority to U.S. Provisional Patent Application No. 63/603,826, filed on Nov. 29, 2023 and titled, “Pressure Sensors and Related Methods,” which is hereby incorporated by reference in its entirety.

### TECHNICAL FIELD

The present disclosure related generally to the field of pressure sensors. More particularly, some embodiments related to pressure sensors that comprise a polysilicon layer coupling a top glass layer to a die.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1A is an isometric view of a pressure sensor, according to an embodiment.

FIGS. 1B and 1C are top and bottom views, respectively, of the pressure sensor.

FIG. 1D is a cross-sectional view of the pressure sensor taken along plane 1D-1D shown in FIG. 1B.

FIGS. 2A-2D are cross-sectional views illustrating a method of forming the pressure sensor, according to an embodiment.

FIG. 3 is a top view of a wafer, according to an embodiment.

### DETAILED DESCRIPTION

The components of the embodiments as generally described and illustrated in the figures herein can be arranged and designed in a wide variety of different configurations. Thus, the following more detailed description of various embodiments, as represented in the figures, is not intended to limit the scope of the present disclosure, but is merely representative of various embodiments. While various aspects of the embodiments are presented in drawings, the drawings are not necessarily drawn to scale unless specifically indicated.

The phrase “coupled to” is broad enough to refer to any suitable coupling or other form of interaction between two or more entities, comprising mechanical interaction. Thus, two components may be coupled to each other even though they are not in direct contact with each other. The phrases “attached to” or “attached directly to” refer to interaction between two or more entities which are in direct contact with each other and/or are separated from each other only by a polysilicon layer.

Embodiments disclosed herein related to pressure sensors and methods of making the same. An example pressure sensor comprises a die. The die comprises at least one lateral section and a diaphragm extending between opposing portions of the lateral section. The lateral section and the diaphragm define a top surface and the lateral section define a bottom surface opposite the top surface. The lateral section and the diaphragm partially define a first cavity. The pressure sensor further comprises a top glass layer positioned adjacent to a portion of the top surface. The top glass layer partially defines a second cavity adjacent to the diaphragm. The pressure sensor also comprises a polysilicon layer between the top glass layer and a corresponding portion of the top surface. The polysilicon layer couples the top glass layer to the die.

During operation, the first cavity is exposed to a pressure in an external environment outside of the pressure sensor. The pressure in the first cavity may be different than the pressure in the second cavity. For example, the first cavity may be exposed to a pressure of about 0.5 bar to 40 bar and the pressure in the second cavity may be about 10⁻¹ Pa or less (i.e., the second cavity is a vacuum). The different pressure between the first and second cavities may cause the diaphragm to bend. The extent that the diaphragm bends may be used to determine the pressure in the first cavity and, in turn, the pressure in the environment.

In an example, the pressure sensor comprises at least one piezoresistive material disposed on or embedded in the die. The piezoresistive material may be positioned such that the piezoresistive material has a compressive or tensile load applied thereto as the diaphragm bends. The compressive or tensile load causes the resistivity of the piezoresistive material to change. The resistivity of the piezoresistive material may be measured by measuring the difference between the input voltage or current against an output voltage or current. The different between the input and output voltages or currents may be used to determine the extent of bending in the diaphragm which, in turn, indicates the pressure in the first cavity.

At least some conventional pressure sensors use an aluminum layer to at least one of couple one or more components of the pressure sensor together, to form electromagnetic shielding, or to form a hermetic seal. However, using the aluminum layer to couple the top glass layer to the die of the pressure sensors disclosed herein may cause one or more issues. For example, using the aluminum layer to couple the top glass layer to the die may strain the die and, in particular, the diaphragm. The strain may be caused by the different coefficient of thermal expansion between the aluminum layer and the primary material that forms the die (e.g., silicon) and because the aluminum layer may resist returning to its original shape after being deformed (e.g., the aluminum layer is less elastic than the primary material that forms the die). The strain caused by the aluminum layer may affect the bending of the diaphragm which, in turn, decreases the accuracy of the pressure sensor. The pressure sensors disclosed herein use the layer coupling the top glass layer to the die to form a hermetic seal for the second cavity such that the pressure in the second cavity remains constant and known. However, the aluminum layer may also be susceptible to minor leaks. Such leaking may change the pressure in the second cavity which, again, affects the bending of the diaphragm over time and the accuracy of the pressure sensors. To correct these issues, the pressure sensors disclosed herein comprising aluminum may need to be subjected to time consuming post-manufacturing processes after coupling the top glass layer to the die to minimize the strain caused by the aluminum layer. Further, whether the aluminum layer forms an effective hermetic seal may only be determined after completely forming the pressure sensor die and the post-manufacturing processes are performed. As such, significant time and material is wasted if the aluminum layer allows minor leaks.

The pressure sensors disclosed herein use a polysilicon layer to couple the top glass layer to the die instead of using the aluminum layer. Unlike aluminum, the polysilicon layer behaves similar to the die. For example, the polysilicon layer exhibits a coefficient of thermal expansion that is closer to the coefficient of thermal expansion of the die and polysilicon is more likely to return to its original shape when deformed than aluminum. As such, the polysilicon layer strains the die significantly less than the aluminum layer. For example, the strain caused by the polysilicon layer may be negligible. It has also been found that the polysilicon layer forms a more reliable hermetic seal compared to the aluminum layer.

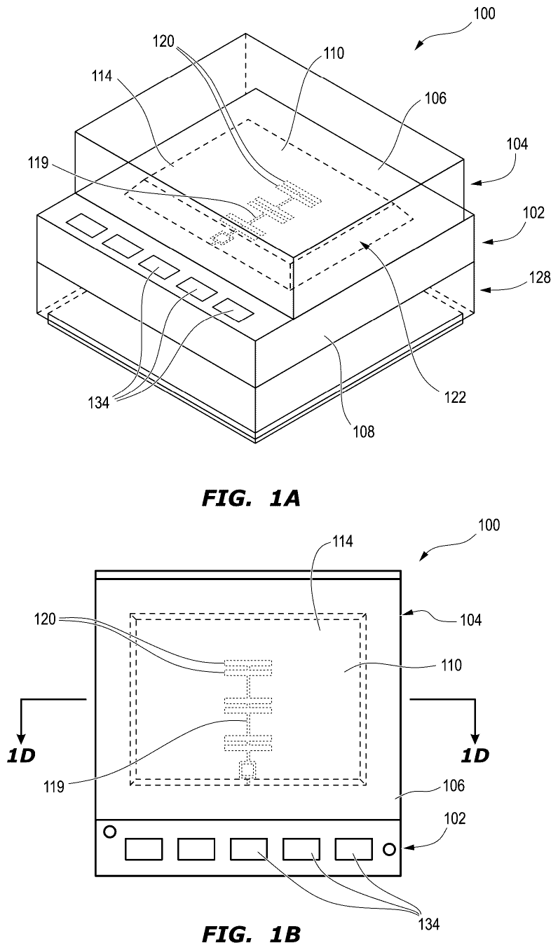

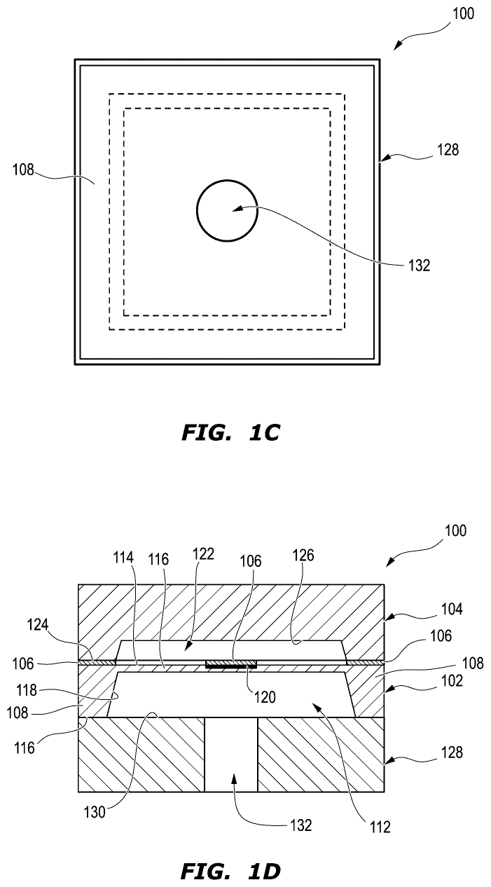

FIG. 1A is an isometric view of a pressure sensor 100, according to an embodiment. FIGS. 1B and 1C are top and bottom views, respectively, of the pressure sensor 100. FIG. 1D is a cross-sectional view of the pressure sensor 100 taken along plane 1D-1D shown in FIG. 1B. The pressure sensor 100 comprises a die 102 and a top glass layer 104 coupled to the die 102 using a polysilicon layer 106.

The die 102 comprises at least one lateral section 108 and a diaphragm 110. The diaphragm 110 may extend between opposing portions of the lateral section 108. The lateral section 108 and the diaphragm 110 collectively define at least a portion of a first cavity 112. The lateral section 108 may exhibit a thickness that is significantly greater than the thickness of the diaphragm 110. The relatively large thickness of the lateral section 108 allows the lateral section 108 to remain rigidity and substantially maintain it shape regardless of the pressure in the first cavity 112. The relatively small thickness of the diaphragm 110 allows the diaphragm 110 to bend or otherwise deflect when the pressure in the first cavity 112 changes.

The die 102 comprises a top surface 114 and a bottom surface 116 opposite the top surface 114. The top surface 114 is defined by the lateral section 108 and the diaphragm 110. The bottom surface 116 is defined by the lateral section 108. The die 102 may also comprise at least one first cavity surface 118. The first cavity surface 118 comprises the surface(s) of the lateral section 108 and the diaphragm 110 that define the first cavity 112.

Generally, the die 102 is formed from silicon, such a single crystal silicon. In an example, a significant majority of the die 102 may be formed from N-type silicon. Forming the die 102 from N-type silicon may cause the die 102 to act as an electromagnetic shield that protects any electronic components formed in or on the die 102. In an example, the die 102 may comprise P-type silicon or semi-conductor silicon. It is noted that the die 102 may comprise non-silicon materials. The die 102 may exhibit a thickness of about 0.2 mm to about 0.75 mm, such as about 0.4 mm.

The die 102 may comprise one or more layers or coatings formed thereon other than the polysilicon layer 106. Examples of such layers and coatings comprise an oxide layer (e.g., a silicon oxide layer), an oxidation barrier, or any other suitable layer or coating formed on an exterior surface of the die 102. The one or more layers or coatings may be formed on at least a portion of one or more surfaces of the die 102. For example, a silicon oxide layer may form on on exposed surfaces of the die 102 during use since portions the die 102 may be exposed to an oxidizing atmosphere during use. It is noted that the layers or coatings may form a portion of at least one of the top surface 114, the bottom surface 116, or the first cavity surface 118.

The die 102 may comprise one or more electronic components (e.g., circuitry) disposed therein or embedded therein. In an example, the electronic components may comprise one or more wires 119. The wires 119 may connect the electronic components (e.g., the piezoresistive material 120) of the die 102 together and allow the electronic components to be in electronic communication with the inputs and outputs 134 of the pressure sensor 100. The wires 119 may be formed by doping selected portions of the die 102, coating the die 102, or using any suitable technique.

The die 102 may comprise electronic components that are configured to detect the pressure. In an embodiment, the pressure sensor 100 is a piezoresistive pressure sensor. In such an embodiment, the electronic components comprise at least one piezoresistive material 120 that is at least partially disposed on or embedded in the diaphragm 110 of the die 102. For example, the piezoresistive material 120 may be a P-type silicon region formed in the die 102. The piezoresistive material 120 disposed on the diaphragm 110 will have a compressive or tensile load applied thereto as the diaphragm 110 bends which changes the resistivity of the piezoresistive material 120. The change in the resistivity of the piezoresistive material 120 may be detected to determine the extent that the diaphragm 110 bends and the pressure in the first cavity 112 that causes the diaphragm 110 to bend in such a manner. In a particular embodiment, a plurality of piezoresistive materials 120 may be disposed on or embedded in the die 102. The plurality of piczoresistive materials 120 allow the bend in the diaphragm 110 at various locations to be measured since different regions of the diaphragm 110 may curve more or less than other regions. The plurality of piezoresistive materials 120 may be arranged in parallel, series, or a combination of the two. For example, the plurality of piezoresistive materials 120 may be arranged in a wheatstone bridge. It is noted that the pressure sensor 100 may be a pressure sensor other and or in addition to a piezoresistive pressure sensor. For example, the pressure sensor 100 may comprise a capacitive pressure sensor or a stain gauge pressure sensor. In such an example, the pressure sensor 100 may comprise a capacitor or strain gauge formed on, disposed on, or embedded in the diaphragm 110 of the die 102 instead of or in addition to the piezoresistive material 120.

The electronic components of the die 102 may include electronic components other than or in addition to the wires 119 and/or the piezoresistive material 120. For example, the electronic components may include at least one aluminum contact at least partially formed on the die 102. The aluminum contact may be electrically coupled to the wires 119 and may facilitate contact with cables connected to the input and outputs 134. It is noted that the aluminum contacts may be spaced from the diaphragm 110 and the second cavity 122 by at least a portion of the polysilicon layer 106 to prevent the aluminum contacts from straining the diaphragm 110 and adversely affecting the hermetic seal.

The electronic components may be formed using any suitable technique, such as by printing the electronic components on a surface of the die 102, forming one or more recesses in the die 102 and disposing the electronic components in the recesses, or doping the bulk material of the die 102 to form the electronic components. In a particular example, the electronic components may be formed by doping the bulk structure of the die 102. For example, the wires 119 and/or the piezoresistive material 120 may be formed on a silicon die 102 by doping select regions of the silicon die 102, wherein the composition and concentration of the dopant causes the selected regions of the silicon die 102 to be the wires 119 and/or the piezoresistive material 120. Forming the electronic components via doping prevents or at least minimizes the electronic components from inducing strains in the diaphragm 110. The electronic components may be disposed on or embedded in the top surface 114 of the die 102 since the top surface 114 will be protected (e.g., covered) by the top glass layer 104 and/or the polysilicon layer 106.

As previously discussed, the pressure sensor 100 comprises a top glass layer 104. The top glass layer 104 may perform one or more functions. In an example, as will be discussed in more detail below, the top glass layer 104 is configured to define a second cavity 122. As such, the top glass layer 104 may be configured to not collapse at the operating pressures of the pressure sensor 100. The top glass layer 104 may be substantially impermeable to gases such that the top glass layer 104 maintains the second cavity 122 in a vacuum or otherwise prevents changes in the pressure of the second cavity 122. In an example, the top glass layer 104 may provide some rigidity and structure to the pressure sensor 100 because the diaphragm 110 is likely to break without providing additional rigidity and structure to the die 102. In an example, the top glass layer 104 provides a physical barrier that protects the electronic components disposed on the top surface 114 of the die 102.

The top glass layer 104 comprises a bottom surface 124. The bottom surface 124 of the top glass layer 104 is positioned adjacent to a portion of the top surface 114 of the die 102. It is noted that the bottom surface 124 of the top glass layer 104 may not contact the top surface 114 of the die 102 since the polysilicon layer 106 is positioned between at least a portion of the bottom surface 124 of the top glass layer 104 and at least a portion of the top surface 114 of the die 102.

As previously discussed, the top glass layer 104 partially defines a second cavity 122. For example, the top glass layer 104 comprises at least one second cavity surface 126 that partially defines the second cavity 122. The second cavity surface 126 may extend from the bottom surface 124 such that the bottom surface 124 is completely enclosed (e.g., surrounded) by the bottom surface 124. As such, the second cavity 122 may be isolated from an external environment. The second cavity 122 is positioned adjacent to at least the diaphragm 110 and above the diaphragm 110 (i.e., adjacent to the top surface 114 and on a side of the diaphragm 110 opposite the first cavity 112) thereby allowing the diaphragm 110 to bend into the second cavity 122. It is noted that the second cavity 122 may also be defined by at least one of the top surface 114 of the die 102, the polysilicon layer 106, or the electronic components disposed on or embedded in the die 102.

In an embodiment, the pressure sensor 100 is an absolute pressure sensor. In such an embodiment, the second cavity 122 may exhibit a vacuum. For example, the second cavity 122 may exhibit a pressure of about 10⁻¹ Pascal (“Pa”) or less, about 10⁻² Pa or less, about 10⁻³ Pa or less, about 10⁻⁴ Pa or less, or in ranges of about 10⁻¹ Pa to about 10⁻³ Pa, about 10⁻² Pa to about 10⁻⁴ Pa, or about 10⁻³ Pa to about 10⁻⁵ Pa. In an embodiment, the pressure sensor 100 is a gage pressure sensor. In such an embodiment, the second cavity 122 may exhibit a pressure of about 101 kPa.

The top glass layer 104 may be formed from any suitable material. In an example, the top glass layer 104 may comprise a borosilicate glass (e.g., bolosilicate glass with a high alkali ion concentration), such as Borofloat 33 manufactured by the Schott Company. Selecting the top glass layer 104 to comprise borosilicate glass may facilitate bonding the top glass layer 104 to the die 102 via the polysilicon layer 106 using an anodic bonding process. The top glass layer 104 may exhibit a thickness of about 0.25 mm to about 1 mm, such as about 0.5 mm.

The polysilicon layer 106 couples the die 102 and the top glass layer 104 together. As such, the polysilicon layer 106 is positioned between at least a portion of bottom surface 124 of the top glass layer 104 and a corresponding portion of the top surface 114 of the die 102. In an embodiment, the polysilicon layer 106 also acts as an electromagnetic shield. In such an embodiment, the polysilicon layer 106 may also cover the electronic components of the pressure sensor 100 to prevent damage to these components. For example, the polysilicon layer 106 may cover the wires 119 and the piezoresistive material 120. That said, the polysilicon layer 106 may not be disposed on the diaphragm 110 except where needed (e.g., on the electronic components that are disposed on or embedded in the diaphragm 110) or the polysilicon layer 106 may be disposed on a limited portion of the diaphragm 110 (e.g., about 15% or less of the surface area of the diaphragm 110) since the polysilicon layer 106 may have some minimal effect on the bending of the diaphragm 110. As such, in an example, the polysilicon layer 106 may only be disposed on a lateral peripheral portions of the top surface 114 of the die 102 that are above the lateral section 108, the wires 119, and the piezoresistive material 120.

The polysilicon layer 106 is not single crystal silicon. Instead, the polysilicon layer 106 may comprise a plurality of silicon grains (e.g., a plurality of silicon grains having no preferred crystallographic orientation), amorphous silicon, or combinations thereof (e.g., the polysilicon layer 106 comprises regions of polycrystalline silicon and regions of amorphous silicon). In a particular example, the polysilicon layer 106 comprises amorphous silicon. The polysilicon layer 106 may not be not single crystal silicon because the polysilicon layer 106 is deposited on the die 102 instead of grown. In certain applications the polysilicon layer 106 may more efficiently couple the top glass layer 104 to the die 102 than if the polysilicon layer 106 was replaced with single crystal silicon or polycrystalline silicon exhibiting a preferred crystallographic orientation. Furthermore, in some instances, the polysilicon layer 106 may form a better hermetic seal for the second cavity 122 as compared to use of aluminum in place of the polysilicon layer 106.

In an embodiment, the polysilicon layer 106 may comprise phosphorus which allows the polysilicon layer 106 to act as an electromagnetic shield. For example, the polysilicon layer 106 may be formed from high purity silicon, which exhibits limited electrical conductivity. Adding phosphorus to the polysilicon layer 106 increases the electrical conductivity of the polysilicon layer 106. The increased electrical conductivity of the polysilicon layer 106 allows the polysilicon layer 106 to act as an electromagnetic shield. The phosphorus may be added to one or more select regions of the polysilicon layer 106 (e.g., regions of the polysilicon layer 106 that cover electrical components) or, more preferably, all of the polysilicon layer 106 thereby allowing the polysilicon layer 106 to act as an electromagnetic shield for a greater percentage of the die 102. In an embodiment, the phosphorus is present near an exterior surface of the polysilicon layer 106 or, more preferably, substantially homogenously throughout all of the thickness of the polysilicon layer 106 which increases the ability of the polysilicon layer 106 to act as an electromagnetic shield. The phosphorus may be added (e.g., doped into) the polysilicon layer 106 using any suitable technique, such as an ion implantation technique. It is noted that the polysilicon layer 106 may comprise a dopant other than phosphorus, such as any group 15 element (e.g., nitrogen, arsenic, or antimony). That said, it is noted the phosphorus implantation into polysilicon may be more predictable and performed more cost-effectively than doping the polysilicon layer 106 with other dopants.

The polysilicon layer 106 may exhibit a thickness that is about 1 μm or less, about 750 nm or less, about 500 nm or less, about 400 nm or less, about 300 nm or less, about 250 nm or less, about 200 nm or less, about 150 nm or less, about 100 nm or less, about 75 nm or less, about 50 nm or less, or in ranges of about 25 nm to about 75 nm, about 50 nm to about 100 nm, about 75 nm to about 150 nm, about 100 nm to about 200 nm, about 150 nm to about 250 nm, about 200 nm to about 300 nm, about 250 nm to about 400 nm, about 300 nm to about 500 nm, about 400 nm to about 750 nm, or about 500 nm to about 1 μm. The thickness of the polysilicon layer 106 may be selected to be sufficiently large to minimize any stresses from the interface between the top glass layer 104 and the polysilicon layer 106 from straining the diaphragm 110. It is noted that the above thicknesses may be sufficient as minimizing such stress though, generally, increasing the thickness of the polysilicon layer 106 decreases such stresses. The thickness of the polysilicon layer 106 may be selected to be sufficiently large for phosphorous implantation.

In an embodiment, the pressure sensor 100 may comprise a bottom glass layer 128. The bottom glass layer 128 comprises a top surface 130. The top surface 130 of the bottom glass layer 128 is positioned adjacent to a portion of the bottom surface 116 of the die 102. As such, the top surface 130 of the bottom glass layer 128 may define a portion of the first cavity 112.

The bottom glass layer 128 may provide one or more functions. In an example, the bottom glass layer 128 may provide some rigidity and structure to the pressure sensor 100 because the diaphragm 110 is likely to break without providing additional rigidity and structure to the die 102. In an example, the bottom glass layer 128 provides a physical barrier that protects the first cavity 112 and, more particularly, prevents or inhibits relatively large solid objects from entering the first cavity 112 and damaging the diaphragm 110.

The bottom glass layer 128 may be formed from any suitable material. In an example, the bottom glass layer 128 may comprise a borosilicate glass (e.g., bolosilicate glass with a high alkali ion concentration), such as Borofloat 33 manufactured by the Schott Company. Selecting the bottom glass layer 128 to comprise borosilicate glass may facilitate bonding the bottom glass layer 128 to the die 102 using an anodic bonding process. In an example, the bottom glass layer 128 is the same as or different than the top glass layer 104. The bottom glass layer 128 may exhibit a thickness of about 0.25 mm to about 1 mm, such as about 0.5 mm.

The bottom glass layer 128 may be coupled to the die 102 using any suitable technique. In an embodiment, the bottom glass layer 128 is coupled to the die 102 using a polysilicon layer similar to the polysilicon layer 106. In an embodiment, the bottom glass layer 128 is not coupled to the die 102 using a polysilicon layer since the bottom glass layer 128 is spaced from the diaphragm 110 by the lateral section 108 and, thus, the method used to couple the bottom glass layer 128 to the die 102 negligibly strains the diaphragm 110. In such an example, the bottom glass layer 128 may be coupled to the die 102 using an aluminum layer.

The bottom glass layer 128 may define a hole 132 extending therethrough. The hole 132 extends from the first cavity 112. As such, the hole 132 allows the first cavity 112 to be in fluid communication with an exterior environment of the pressure sensor 100. In other words, the hole 132 allows the first cavity 112 to exhibit a pressure that is the same as the pressure outside of the pressure sensor 100. The pressure sensor 100 is able to detect the pressure outside of the pressure sensor 100 since the hole 132 allows the first cavity 112 exhibits the pressure outside of the pressure sensor 100. The hole 132 may exhibit a diameter that is about 0.25 mm to about 1 mm, such as about 0.5 mm. The hole 132 may be selected to prevent or inhibit relatively large solid particles reaching and damaging the diaphragm 110.

The pressure sensor 100 may comprise one or more inputs and outputs 134. The inputs and outputs 134 may be formed on the die 102. The inputs and outputs 134 allow the pressure sensor 100 to be electrically coupled to a controller (not shown) via cables and allows the pressure sensor 100 to provide data to the controller. In an example, the controller may be configured to input a voltage or current to the pressure sensor 100 and the pressure sensor 100 is configured to output a voltage or current to the controller. As previously discussed, bending of the diaphragm 110 changes the resistivity of the piezoresistive material 120. The change of resistivity of the piezoresistive material 120 may be reflected by a change in the voltage or current outputted from the pressure sensor 100. The controller may use the change in the output voltage or current to determine an ambient pressure of the pressure sensor 100.

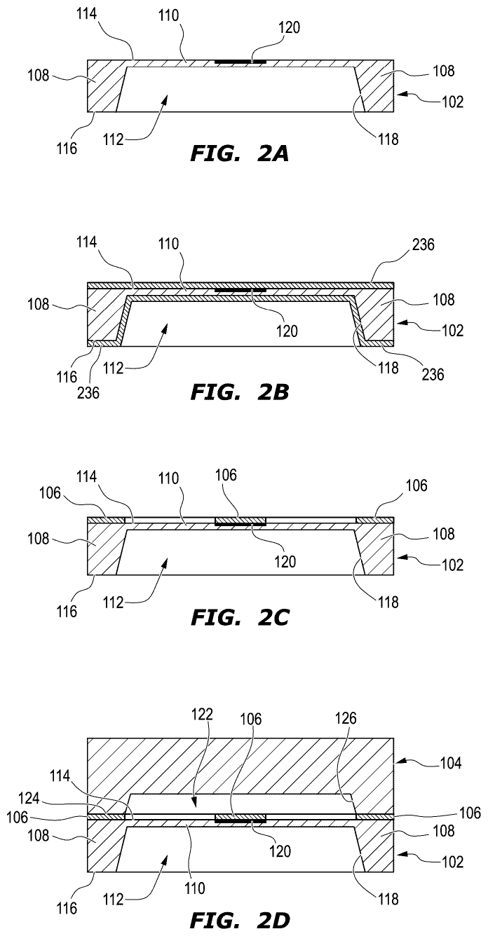

FIGS. 2A-2D are cross-sectional views illustrating a method of forming the pressure sensor 100, according to an embodiment. Referring to FIG. 2A, the die 102 may be provided. In an embodiment, as illustrated, the die 102 may be provided it is final configuration. For example, the die 102 may be provided that comprises a lateral section 108 and a diaphragm 110 that defines a first cavity 112. The die 102 may also be provided with at least one of wires 119, the piezoresistive material 120, or the other electrical components (e.g., the aluminum contacts) disposed thereon or embedded therein. In an embodiment, the die 102 may be provided with the bottom glass layer 128 (not shown in FIGS. 2A-2D) bonded to the die 102.

In an embodiment, the die 102 is not provided in its final configuration. In such an embodiment, one or more processes may be performed to form the die 102. Such processes may comprise forming one or more layers, masking one or more portions of the material that forms the die 102, removing material from the portions of the material that form the die 102, cleaning one or more portions of the material that forms the die 102 (e.g., removing an oxide layer), etching one or more portions of the material that forms the die 102, or any other suitable process. In an example, forming the die 102 may comprise providing a primary material (e.g., silicon material). In such an example, portions of the primary material may be removed using any suitable technique to form the first cavity 112. In an example, forming the die 102 may comprise forming at least one the wires 119, the piezoresistive material 120, or electronic components using any suitable technique, such as ion implantation.

In an embodiment, forming the die 102 may comprise coupling the bottom glass layer 128 to the die 102. The bottom glass layer 128 may be bonded to the die 102 using any suitable technique. In an example, the bottom glass layer 128 may be coupled to the die 102 using an aluminum layer. In such an example, the aluminum layer bonding the bottom glass layer 128 to the die 102 is sufficiently spaced from the diaphragm 110 that the aluminum layer applies a negligible strain to the diaphragm 110, even without any post-manufacturing techniques. In an example, the bottom glass layer 128 may be bonded to the die 102 using a polysilicon layer that is substantially similar to the polysilicon layer 106. In an embodiment, the bottom glass layer 128 may be coupled to the die 102 in the same process that couples the top glass layer 104 to the die 102.

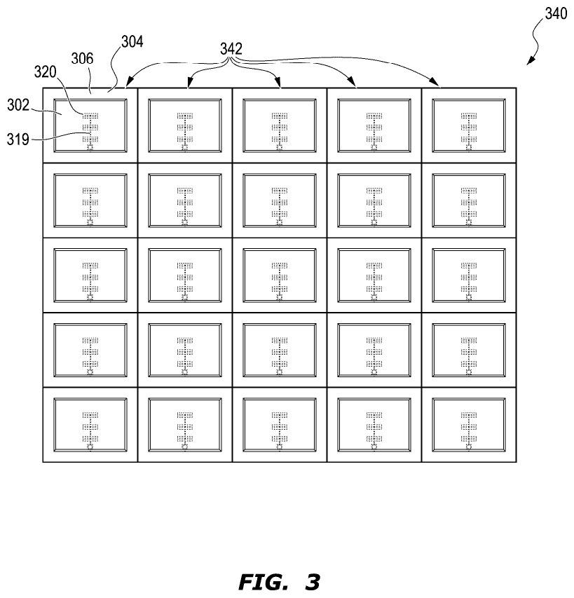

Referring to FIG. 2B, a polysilicon material 236 is deposited on one or more surfaces of the die 102. The polysilicon material 236 may be deposited on the surfaces of the die 102 using any suitable technique. In an example, the polysilicon material 236 is deposited on the die 102 using chemical vapor deposition, such as low pressure chemical deposition in a low vacuum (e.g., a pressure of about 0.133 Pa to about 13.3 kPa) and/or an inert environment (e.g., argon gas). In such an example, the polysilicon material 236 may be deposited on the exposed surfaces of the die 102, such as the top surface 114, the bottom surface 116, and the first cavity surfaces 118. The polysilicon material 236 may also be deposited on the lateral surface if, at the time of deposition, the die 102 does not form part of a wafer (e.g., wafer 340 of FIG. 3). The polysilicon material may comprise, for example, polycrystalline silicon having no preferred crystallographic orientation or amorphous silicon. The polysilicon material may exhibit any suitable thickness, such as any of the thicknesses disclosed herein.

Referring to FIG. 2C, the method may comprise removing the polysilicon material 236 from a portion of the die 102 to form the polysilicon layer 106. For example, the method may comprise removing the polysilicon material 236 from the die 102 such that the remaining polysilicon is substantially only positioned on portions of the die 102 that are adjacent to the top glass layer 104 and/or covering the electrical components (e.g., the piezoresistive material 120). The polysilicon material 236 may be removed using any suitable technique. In an example, one or more masks may be formed on portions of the polysilicon material 236 that are to remain on the die 102. In such an example, the unmasked portions of the polysilicon material 236 may be removed using a photolithography technique. After the photolithography technique, the one or more masks may be removed.

Referring to FIG. 2D, the top glass layer 104 may be coupled to the die 102 using the polysilicon layer 106. In an embodiment, an anodic bonding technique may be used to couple the top glass layer 104 may be coupled to the die 102 using the polysilicon layer 106. The anodic bonding process comprising heating the die 102, the top glass layer 104, and the polysilicon layer 106 to a temperature of about 200° C. to about 550° C., such as about 200° C. to about 300° C., about 250° C. to about 350° C., about 300° C. to about 400° C., about 350° C. to about 450° C., about 400° C. to about 500° C., or about 450° C. to about 550° C. It is noted that heating the top glass layer 104, and the polysilicon layer 106 to a temperature above or near 550° C. may modify the electrical characteristics of the pressure sensor 100. The anodic bonding process also comprises applying an electric field to the die 102, the top glass layer 104, and the polysilicon layer 106. The electric field may exhibit a magnitude of about 800 kV/m to about 1300 kV/m, such as in ranges of about 800 kV/m to about 1000 kV/m, about 900 kV/m to about 1050 kV/m, about 1000 kV/m to about 1100 kV/m, about 1050 kV/m to about 1150 kV/m, about 1100 kV/m to about 1200 kV/m, or about 1150 kV/m to about 1300 kV/m. For example, the electric field may be generated by applying a voltage (e.g., a voltage of about 800 V to about 1000 V, about 900 V to about 1100 V, or about 1000 V to about 1200 V) between electrodes that are spaced from each other by a distance (e.g., a distance of 500 μm to about 1.5 mm). The anodic bonding process may take about 30minutes to about 3 hours, such as in ranges of about 30 minutes to about 1 hour, about 45 minutes to about 1.5 hours, about 1 hour to about 2 hours, about 1.5 hours to about 2.5 hours, or about 2 hours to about 3 hours. It is noted that the time period of the anodic bonding process is significantly less than the time period needed to perform the post-manufacturing process for an aluminum layer if the polysilicon layer 106 was replaced with the aluminum layer. The anodic bonding process may be monitored using any suitable process, such as by monitoring the current used to generate the electric field and/or the charge on any of the electrodes. In an embodiment, the top glass layer 104 may be coupled to the die 102 using the polysilicon layer 106 using a technique other than or in addition to an anodic bonding process. In such an example, the top glass layer 104 may be coupled to the die 102 using fusion bonding, applying heat and pressure simultaneously to the die 102 and the top glass layer 104, or any other suitable technique.

In an embodiment, when the pressure sensor 100 is an absolute pressure sensor, the die 102 and the top glass layer 104 are coupled together while the die 102 and the top glass layer 104 are in a vacuum. The vacuum may exhibits any of the vacuum pressures disclosed herein. Coupling the die 102 and the top glass layer 104 together while in a vacuum causes the second cavity 122 to exhibit a vacuum. In an embodiment, when the pressure sensor 100 is a gauge pressure sensor, the die 102 and the top glass layer 104 are coupled together while exposed to atmospheric pressure (e.g., about 101 kPa).

The method to form the pressure sensor 100 may comprise one or more acts that are not illustrated in FIGS. 2A-2D. For example, the method to form the pressure sensor 100 may comprise testing the hermetic seal formed by the polysilicon layer 106. In other words, the method to form the pressure sensor 100 may comprise determining whether the pressure in the second cavity 122 may unsatisfactory change during operating. Testing the hermetic seal formed by the polysilicon layer 106 may comprise exposing the pressure sensor 100 to a helium atmosphere exhibiting a pressure that is greater than the pressure in the second cavity 122. Helium may relatively quickly enter the second cavity 122 if there is any defect in the polysilicon layer 106 due to the small size of the helium atoms. After exposing the pressure sensor 100 to the helium atmosphere, the pressure sensor 100 may be tested to determine if there is any helium in the second cavity 122.

In an embodiment, the pressure sensors disclosed herein may be formed on a wafer. FIG. 3 is a top view of a wafer 340, according to an embodiment. It is noted that like features are designated with like reference numerals, with the leading digits incremented to “3.” For example, the embodiment depicted in FIGS. 3 comprises a die 302 that may, in some respects, resemble the die 102 of FIGS. 1A-2D. Relevant disclosure set forth above regarding similarly identified features thus may not be repeated hereafter. Moreover, specific features of the pressure sensors and related components shown in FIGS. 1A-2D may not be shown or identified by a reference numeral in the drawings or specifically discussed in the written description that follows. However, such features may clearly be the same, or substantially the same, as features depicted in other embodiments and/or described with respect to such embodiments. Accordingly, the relevant descriptions of such features apply equally to the features of the pressure sensors and related components depicted in FIG. 3. Any suitable combination of the features, and variations of the same, described with respect to the pressure sensors 100 and related components illustrated in FIGS. 1A-2D can be employed with the pressure sensors and related components of FIG. 3, and vice versa.

The wafer 340 comprises a plurality of devices 342. In an embodiment, each of the devices 342 is a complete pressure sensor that is the same as any of the pressure sensors disclosed herein. In an embodiment, each of the devices 342 is a portion of any of the pressure sensors disclosed herein. In other words, each of the devices 342 is a component of any of the pressure sensors disclosed herein. In an example, each of the devices 342 may comprise a die 302. The die 302 may be the same or substantially similar to any of the dies disclosed herein (e.g., each of the dies comprises a top surface and defines a first cavity). The die 302 may comprise electrical components disposed thereon or embedded therein, such as wires 319 or piezoresistive materials 320. In an example, each of the devices 342 may comprise at least one polysilicon layer 306 disposed thereon. In an example, each of the device 342 may comprise a top glass layer 304 and/or a bottom glass layer coupled to the die 302.

Each of the devices 342 of the wafer 340 are attached together. For example, the wafer 340 may comprise or otherwise be formed from a single piece of silicon wafer and a plurality of dies may be manufactured on the single piece of silicon wafer. Each of the devices 342 of the wafer 340 may be detached (e.g., cut) from each other at some time period after forming the wafer 340. The devices 342 may be detached from each other using any suitable technique, such as using a diamond scribe, a dicing saw, or laser cutting. In an embodiment, the devices 342 are detached from each other only after the die 102 and the top glass layer 104 are coupled together (e.g., the pressure sensors are completely manufactured).

The pressure sensors disclosed herein may be provided as one or more distinct pressure sensors (i.e., a pressure sensor that is not attached to another pressure sensor, as shown in FIGS. 1A-1D) or one or more wafers (e.g., wafer 340). Whether the pressures sensors are provided as distinct pressure sensors or as wafers may depend on how difficult it is to handle the pressure sensors. In an embodiment, only one or a few pressure sensors are provided. In such an embodiment, it may be easier to handle distinct pressure sensors rather than detaching the pressure sensors from a wafer. In another embodiment, tens, hundreds, thousands, or even more pressure sensors may need to be handled. In such an embodiment, whether the pressure sensors are provided as distinct pressure sensors or as wafers may depend on the handling capabilities of the handler (e.g., a manufacturer using the pressure sensors). For example, the distinct pressure sensors may be provided in packaging (e.g., tray) when the distinct pressure sensors are provided in such large numbers. In some instance, the handlers may be able to handle the large numbers of distinct pressure sensors in the packaging depending on the equipment of the handler. In such instances, the pressure sensors may be provided as distinct pressure sensors. In other instance, the handler may be unable to handle the large numbers of distinct pressure sensors in the packaging due to the limited equipment thereof. However, the handler may have the capability to detach the pressure sensors from each other when provide in the wafer. As such, in such an instance, the pressure sensors may be provided as wafers since the handler is better equipped to handle the large quantity of pressure sensors as a wafer.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified. Moreover, sub-routines or only a portion of a method described herein may be a separate method within the scope of this disclosure. Stated otherwise, some methods may comprise only a portion of the steps described in a more detailed method.

Reference throughout this specification to “an embodiment” or “the embodiment” means that a particular feature, structure, or characteristic described in connection with that embodiment is comprised in at least one embodiment. Thus, the quoted phrases, or variations thereof, as recited throughout this specification are not necessarily all referring to the same embodiment.

Similarly, it should be appreciated by one of skill in the art with the benefit of this disclosure that in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure comprises all permutations of the independent claims with their dependent claims.

It will be apparent to those having skill in the art that changes may be made to the details of the above-described embodiments without departing from the underlying principles of the present disclosure.

What is claimed is:

1. A pressure sensor, comprising:
a die comprising at least one lateral section and a diaphragm extending between opposing portions of the at least one lateral section, the at least one lateral section and the diaphragm forming a top surface and the at least one lateral section defining a bottom surface opposite the top surface, the at least one lateral section and diaphragm partially defining a first cavity;
a top glass layer adjacent to the at least a portion of the top surface, the top glass layer partially defining a second cavity adjacent to the diaphragm; and
a polysilicon layer at least between a portion of the top surface of the die and a corresponding portion of the top glass layer, the polysilicon layer coupling the top glass layer to the die.

2. The pressure sensor of claim 1, wherein the polysilicon layer is substantially amorphous.

3. The pressure sensor of claim 1, wherein the polysilicon layer exhibits no preferred crystallographic orientation.

4. The pressure sensor of claim 1, wherein the polysilicon layer comprises phosphorus.

5. The pressure sensor of claim 4, wherein the phosphorus is substantially uniformly disposed through the polysilicon layer.

6. The pressure sensor of claim 1, wherein the polysilicon layer is substantially free of aluminum.

7. The pressure sensor of claim 1, further comprising at least one piezoresistive material disposed on or embedded in the die.

8. The pressure sensor of claim 7, wherein the polysilicon layer covers the at least one piezoresistive material.

9. The pressure sensor of claim 1, wherein the second cavity exhibits a pressure of 10⁻¹ Pa or less.

10. The pressure sensor of claim 1, further comprising one or more aluminum contact pads disposed on a portion of the top surface of the die.

11. The pressure sensor of claim 1, further comprising a bottom glass layer adjacent to and coupled to at least a portion of the bottom surface of the die, the bottom glass layer defining an opening.

12. A method to form a pressure sensor, the method comprising:
providing one or more dies, each of the one or more dies comprising at least one lateral section and a diaphragm extending between opposing portions of the at least one lateral section, the at least one lateral section and the diaphragm forming a top surface and the at least one lateral section defining a bottom surface opposite the top surface, the at least one lateral section and diaphragm partially defining a first cavity;
depositing a polysilicon layer on at least a portion of the top surface of the one or more dies;
positioning one or more top glass layers adjacent to at least a portion of the top surface of the one or more dies; and
coupling the one or more top glass layers to the top surface of the one or more dies using the polysilicon layer.

13. The method of claim 12, wherein depositing the polysilicon layer on at least a portion of the top surface of the one or more dies comprises depositing the polysilicon layer on at least a portion of the top surface of the one or more dies using chemical vapor deposition.

14. The method of claim 13, wherein the chemical vapor deposition comprises low pressure chemical deposition in a low vacuum.

15. The method of claim 14, further comprising removing selected portions of the polysilicon layer after depositing the polysilicon layer on at least a portion of the top surface.

16. The method of claim 12, further comprising, after depositing the polysilicon layer and before positioning the one or more top glass layers adjacent to at least a portion of the top surface, adding phosphorus to the polysilicon layer.

17. The method of claim 12, wherein coupling the one or more top glass layers to the top surface of one or more dies comprises using anodic bonding to couplethe one or more top glass layers to the top surface of one or more dies using the polysilicon layer.

18. The method of claim 12, further comprising doping one or more sections of the die to form at least one piezoresistive material.

19. The method of claim 18, wherein depositing the polysilicon layer on at least a portion of the top surface comprises depositing the polysilicon layer on the at least one piezoresistive material.

20. A wafer, comprising:
a plurality of devices attached together, each of the plurality of devices comprising:
a die comprising at least one lateral section and a diaphragm extending between opposing portions of the at least one lateral section, the at least one lateral section and the diaphragm forming a top surface and the at least one lateral section defining a bottom surface opposite the top surface, the at least one lateral section and diaphragm partially defining a first cavity;
a top glass layer adjacent to the at least a portion of the top surface, the top glass layer at least partially defining a second cavity adjacent to the diaphragm; and
a polysilicon layer at least between a portion of the top surface of the die and a corresponding portion of the top glass layer, the polysilicon layer attaching the top glass layer to the die.
